(19) United States
(12) Patent Application Publication
(10) Pub. No.: US 2015/0144254 A1
(43) Pub. Date: May 28, 2015

(54) METHOD FOR PRODUCING AN ENDLESS TRANSPORT BELT

(71) Applicant: manroland web systems GmbH, Augsburg (DE)

(72) Inventors: Stefan ALBRECHT, Neusaess (DE); Norbert ROTHENBERGER, Augsburg (DE); Xaver BACHMEIR, Affing (DE); Stephan FISCHER, Augsburg (DE); Marek JIROUS, Gablingen (DE); Helmut STUHLMILLER, Altenmuenster (DE)

(73) Assignee: manroland web systems GmbH, Augsburg (DE)

(21) Appl. No.: 14/548,055

(22) Filed: Nov. 19, 2014

(30) Foreign Application Priority Data
Nov. 20, 2013 (DE) 10 2013 112 837.8

(51) Int. Cl. B65G 15/34; B29C 65/74

(52) U.S. Cl. CPC B65G 15/34; B29C 65/749; B29L 2031/7092
USPC 156/154

(57) ABSTRACT

A method for producing an endless transport belt for guiding substrates during the printing operation of a printing press is disclosed. The ends of a transport belt are welded together. The transport belt is ground, after one or multiple welding operations without or with the addition of material, to a nominal thickness that is smaller than or equal to the minimal thickness of the transport belt.

This application claims the priority of German Patent Document No. DE 10 2013 112 837.8, filed Nov. 20, 2013, the disclosure of which is expressly incorporated by reference herein.

### BACKGROUND AND SUMMARY OF THE INVENTION

The invention relates to a method for producing an endless transport belt for guiding substrates during the printing process of a printing press, where the ends of a transport belt are welded together.

Such endless belts have been known for some time in order to securely guide flat goods webs, such of a critical material, e.g., having a high tendency to warping, through a machine, for example a printing press. Such belts are disclosed, for example, in WO 82/00975, DE 100 23689 or DE 8915358. They mostly consist of a multi-layered structure, in which a textile fabric layer absorbs the tensioning forces and in which a cover layer is designed so that it can be coated with an adhesive, which establishes the connection between belt and substrate. Today's endless belts mostly consist of polyurethane which is particularly suited for these purposes. It can be additionally melted which makes possible the welding together of the two ends of the belt in the machine into an endless belt. To this end, both ends are melted into an endless transport belt without the addition of adhesive solely by means of heat and pressure.

It has been known for a long time that the joint is more durable when the two ends are formed engaging into one another in a finger-jointed manner. For, by “intermeshing” the joints, the stresses that occur during the operation are distributed over a larger area. Alternatively, a curve profile is disclosed in DE 10 2010 000 855 with which a further stress reduction can be achieved. In order to expand the area of influence of the joint over a larger band region thus averaging it, it is additionally proposed in DE 9000706 to variably configure the position of the fingers over the width of the belt.

For welding the two ends of a transport belt together, hot presses are employed which comprise an upper and a lower heating plate, with which temperatures of approximately 160° C. are achieved. Such a press is disclosed for example in DE 7619756.

It is known that the materially-joined connection of the two ends of the transport belt is created during the welding by material of the cover slab which, under the influence of heat and pressure, is pressed between the textile fibres of the force-transmitting fabric layer. In the process, material shrinkage occurs in the cover slab the manifestation of which is dependent on the temperature, on the pressure and on the length of the weld seam. The longer the seam, the more material is needed for the connection of the fabric layer.

The material shrinkage of the cover slab results in a slightly smaller belt thickness, which becomes noticeable with certain printing methods, for example offset printing, intaglio printing or flexographic printing by a lower ink transfer. The copies printed in the region of the seam therefore have a lower ink density which diminishes the quality of the printed copies.

The invention is therefore based on the object of stating a method for producing an endless transport belt which remedies the thickness difference and of the pressure loss through the welding operation in as easy a manner as possible.

According to the invention, this object is solved in that the transport belt after one or multiple welding operations is ground to a nominal thickness which is smaller than or equal to the minimal thickness of the transport belt.

The invention is based on the consideration that for as high and also even a print quality as possible, differences in the thickness of the transport belt should be avoided and thus in particular the depression in the region of the weld seam offset. Accordingly, it was recognized that the transport belt has a thickness that is adequate for the requirements even in the region of the depression. It was noted, furthermore, that the material of usual transport belts can be removed by a grinding device. For as uniform a thickness of the transport belt as possible, the transport belt following the completion of the welding operations is therefore ground to a nominal thickness which is smaller than or equal to the minimal thickness of the transport belt.

Should the depression after the welding operation be too deep, i.e., with too much material removed through the welding operation, additional material in a preferred embodiment is added to the weld seam prior to the welding. The region of the weld seam in this case substantially corresponds to the overlap region of the two ends on the transport belt, but can also be embodied larger or smaller depending on the welding device and design of the ends of the transport belt. This additional material is materially joined to the transport belt through the welding operation and causes the depth of the depression to be reduced or—with sufficient added material—even an elevation in the region of the weld seam to be formed. Should an elevation form, it is possible to define the new nominal thickness as the original thickness of the transport belt, whereby only the elevation has to be ground by the grinding process. This substantially reduces the grinding work.

For optimally joining the additional material and also optimizing the added material quantity, multiple welding operations are provided in a preferred embodiment, wherein in at least one welding operation additional material is added. Through these additional welding operations, the depression can be filled with additional material step-by-step until the new nominal thickness is in a range that is acceptable for further usage or even until the depression is completely filled and merely an elevation has to be removed during the grinding process.

To further optimize the added material quantity, the depression, in a particularly advantageous embodiment, is measured in its spatial dimensions after the first welding operation and with the help of this data the optimal quantity of the added material determined. Here it is likewise possible to determine the optimal number of further welding operations with the respective added material quantities or even the depression after each welding operation.

In order to do justice to the shape of the depression, which in the edge region is formed flatter and in the middle, i.e., in the region of the joint, is formed deeper, the additional material in an advantageous embodiment is applied in multiple layers. Because of this, the added material quantity is adapted to the typical forms of the depression and optimal filling of the depression achieved. This, too, reduces the subsequent grinding work since the elevation is reduced especially in the edge region of the welding region.

To avoid complicated mounting and tensioning of the endless transport belt, the welding operation, and in particular the grinding operation, are performed, in a preferred embodiment, in the printing press. Accordingly, one of the present transport cylinders or another element, on which the transport belt is supported, is used in an advantageous configuration as a reference surface during the grinding. The grinding device can then be manually or automatically moved in such a manner that it grinds the transport belt to the new nominal thickness with respect to the support surface, i.e., with respect to the surface of the transport cylinder or of the further element.

Here, the grinding device in a preferred configuration is designed in such a manner that it can be moved transversely to the transport belt and the transport belt can thus be ground over the entire width. In addition, the grinding device can be designed to also grind in the longitudinal direction of the transport belt so that the entire width of the depression can be covered. In an alternative or additional embodiment it is also possible to move the transport belt relative to the grinding device in the longitudinal direction. Because of this, grinding of the entire belt to a new nominal thickness, for example, is made possible which is smaller than the original thickness of the transport belt.

The advantages achieved with the invention consist in particular in that through the grinding away of the transport belt to a new nominal value of the thickness or thickness equalization in the region of the joint it is ensured that all copies, even those which are printed in the region of the joint, satisfy the quality requirements.

An exemplary embodiment of the invention is explained in more detail with the help of the drawings.

### BRIEF DESCRIPTION OF THE DRAWINGS

FIGS. 1a-c illustrate the welding operation of the two ends of a transport belt and the thickness profile of the endless transport belt after the welding operation;

FIGS. 2a-c illustrate the welding operation of the two ends of a transport belt using additional material and the thickness profile of the endless transport belt after the welding operation;

FIGS. 3a-d illustrate various options of applying additional material in the region of the joining edge; and

FIGS. 4a-c illustrate the grinding away of the additional material and the thickness profile of the endless transport belt after the grinding operation.

### DETAILED DESCRIPTION OF THE DRAWINGS

The same parts are marked with the same reference characters in all figures.

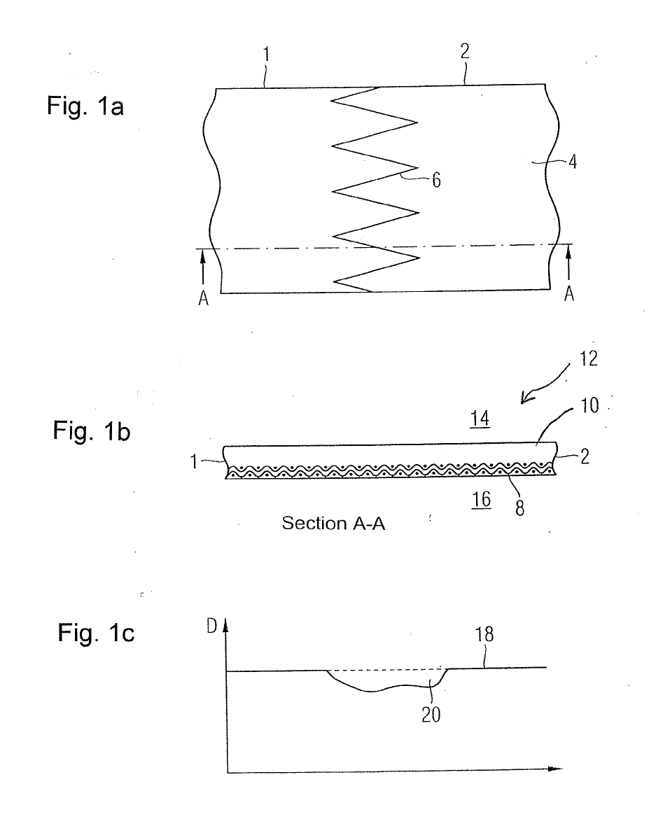

In the exemplary embodiment according to FIGS. 1a-c, the welding operation is shown without additional material added. The two ends 1, 2 of a transport belt 4 are embodied finger-jointed and engage into one another at the seam 6. In FIG. 1b, a cross-section through the transport belt 4 is shown in the region of the weld seam or seam 6 during the welding operation. In cross-section, the structure of the transport belt 4 is more clearly visible. It consists of a textile fabric layer 8 and a cover layer 10, which is coated with an adhesive. The welding operation is performed with the help of a hot press 12, which comprises an upper 14 and a lower heating plate 16, with which temperatures of approximately 160° C. can be achieved. By way of the heating plates, the two ends 1, 2 of the transport belt 4 are connected to one another in a materially joined manner. As is shown by the thickness profile 18 according to FIG. 1c, a depression 20 is formed in the region of the seam 6 through the welding operation.

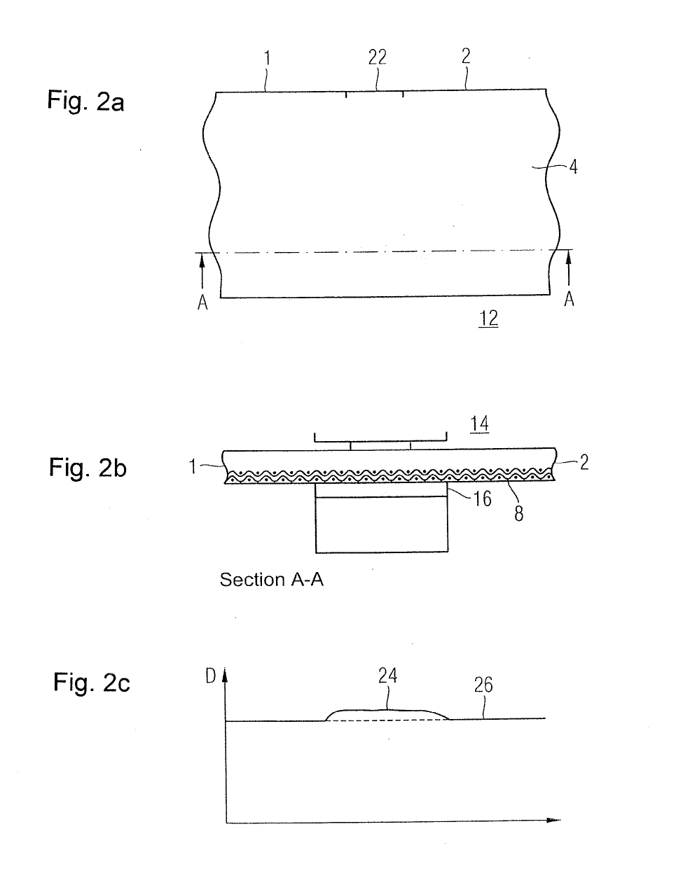

In contrast with the exemplary embodiment according to FIGS. 1a-c, additional material 22 in the form of material strips is placed in the region of the seam 6 before the welding in the exemplary embodiment according to FIGS. 2a-c. By adding the additional material 22, no depression is now formed but the same is completely filled by the additional material 22 and by contrast a minor elevation 24 is created, as is evident from the thickness profile 26 according to FIG. 2c.

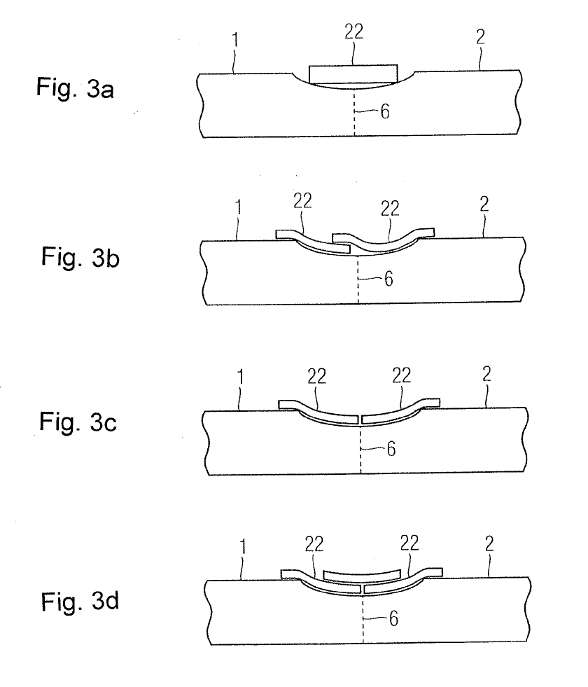

Adding the additional material 22 in this case can be performed even before the first welding operation but it is also possible to initially weld the ends 1, 2 of the transport belt 4 together and fill the depression with additional material 22 in additional welding operations. Accordingly, it is possible by measuring the depression to determine the optimal material quantity. As is evident in the representations of FIGS. 3a-d, the additional material 22 can also be placed in multiple ways. On the one hand it is obviously possible to use a single material strip (FIG. 3a) but on the other hand multiple material strips are also conceivable, which can be arranged in an overlapping (FIG. 3b) or adjacent (FIG. 3c) manner or in multiple layers on top of and adjacent to one another (FIG. 3d). By suitable selection of the arrangement of the additional material 22 the depression 20 can be filled as best as possible so that the elevation 24 is reduced and the subsequent grinding work can therefore be reduced as well.

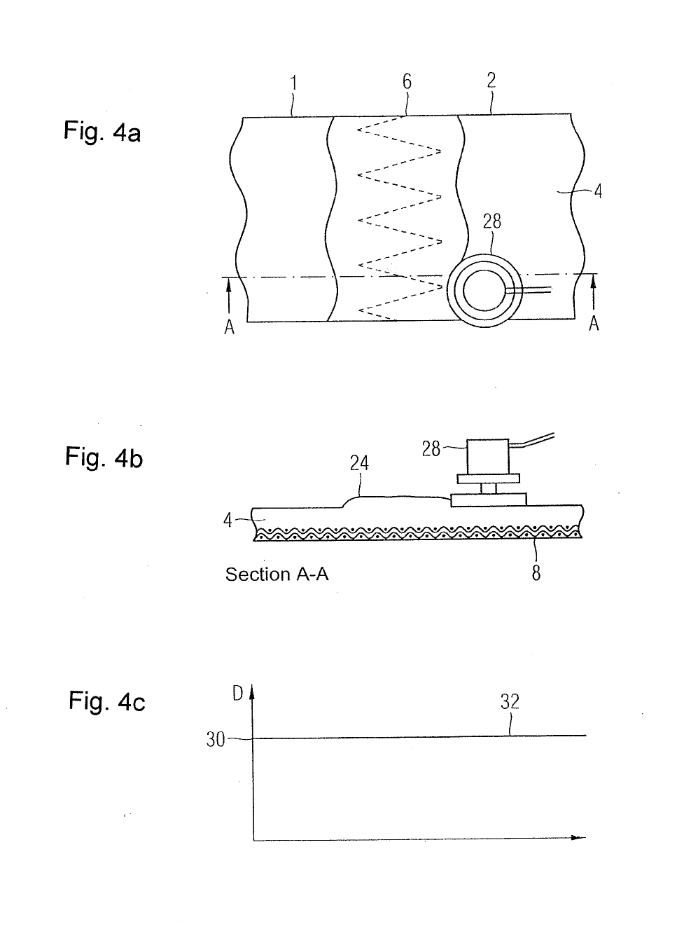

The following grinding process is shown in FIGS. 4a-c. The grinding device 28 moves transversely to the transport belt 4 over the entire width of the transport belt 4, grinding the transport belt 4 to a nominal thickness 30, which is smaller than or equal to the minimal thickness of the transport belt after the welding. In the present case the nominal thickness 30 corresponds to the original thickness of the transport belt 4, but in the case of a remaining depression 22 it can also be smaller than the original thickness of the transport belt 4. As a reference plane for determining the current thickness, the grinding device in this case utilizes the support surface of the transport belt or the lower side of the fabric layer 8. For grinding in the longitudinal direction it is possible that the transport belt under the grinding device is moved in the longitudinal direction and/or even that the grinding device is designed to be moveable in the longitudinal direction. In both cases the grinding device can remove the elevation shown in the exemplary embodiment according to FIGS. 4a-c so that a transport belt with a constant thickness over the entire length and width is created, as is evident from the thickness profile 32 in FIG. 4c.

### LIST OF REFERENCE NUMBERS

1 First end of the transport belt

2 Second end of the transport belt

4 Transport belt

6 Weld seam

8 Fabric layer

10 Cover layer

12 Hot press

14 Upper heating plate

16 Lower heating plate

18 Thickness profile

20 Depression

22 Additional material

24 Elevation

26 Thickness profile

28 Grinding device

30 Nominal thickness

32 Thickness profile

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for producing an endless transport belt for guiding substrates during a printing operation of a printing press, comprising the steps of:
welding ends of a transport belt together in a plurality of welding operations; and
grinding the transport belt after a one of the plurality of welding operations to a nominal thickness which is smaller than or equal to a minimal thickness of the transport belt.

2. The method according to claim 1, wherein prior to the step of welding, further comprising the step of applying material in a region of a weld seam of the transport belt.

3. The method according to claim 1, wherein multiple welding operations are performed prior to the step of grinding and wherein in at least one of the welding operations material is applied in a region of a weld seam of the transport belt.

4. The method according to claim 3, wherein a quantity of the material is determined by measuring a depth and a spatial extent of a form deviation of the transport belt in a region of the weld seam of the transport belt.

5. The method according to claim 2, wherein the material is applied in multiple layers.

6. The method according to claim 1, wherein the grinding step is restricted to a region of a weld seam of the transport belt and wherein the nominal thickness corresponds to an original thickness of the transport belt.

7. The method according to claim 1, wherein the grinding step is performed within the printing press.

8. The method according to claim 1, wherein a support surface, on which the transport belt is supported for the grinding step, is used as a reference surface during the grinding step.

9. The method according to claim 1, wherein during the grinding step a grinding device is moved transversely to the transport belt.

10. The method according to claim 1, wherein during the grinding step a grinding device is moved longitudinally to the transport belt.

11. The method according to claim 1, wherein during the grinding step the transport belt is moved in a longitudinal direction relative to a grinding device.
